(19) United States
(12) Patent Application Publication
(10) Pub. No.: US 2014/0217755 A1
(43) Pub. Date: Aug. 7, 2014

(54) INTERCHANGEABLE DOOR HANDLE SYSTEM

(71) Applicant: Danielle Kom, Miami, FL (US)

(72) Inventor: Danielle Kom, Miami, FL (US)

(21) Appl. No.: 13/757,121

(22) Filed: Feb. 1, 2013

(51) Int. Cl. E05B 3/00; E05B 1/00

(52) U.S. Cl. CPC E05B 3/00; E05B 1/00
USPC 292/336.3

(57) ABSTRACT

An interchangeable door handle system includes a mounting plate having an orifice, a collar surrounding the orifice, an aperture in the collar, wherein the aperture provides access to a lumen of the collar, a clip for insertion into the aperture, a movable ring surrounding the collar, wherein in a first position the ring rests against the clip such that the clip extends through the aperture and into the lumen of the collar and wherein in a second position the ring does not rest against the clip such that the clip does not extend into the lumen of the collar, and a door handle having a cylindrical stem including a gutter, wherein when the ring is in the first position the door handle is secured to the collar, and wherein when the ring is in the second position the door handle is not secured to the door handle and may be removed.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of fixtures for the home, and more particularly relates to the field of door handles and door knobs.

### BACKGROUND OF THE INVENTION

A lockset is the hardware and components that comprise the locking or latching mechanism that can usually be found on a door or other hinged object. The components of a lockset can include (but are not limited to) the door handle, latch bolt, dead bolt, and decorative escutcheons of the door and can consist of mortised or cylindrical mechanisms. The lockset and associated hardware typically defines a door's function and how a user would (or cannot) access the two adjacent spaces defined by the opening associated with the lockset. A door handle, also known as a door knob or handle, is the fixed mechanism used by a person to open or close a door. In the United States, a door handle generally can refer to any fixed or lever-operated door latch device, including on car doors. The term door knob tends to refer to round operating mechanisms.

One of the drawbacks of conventional locksets is that once installed, the locksets are fixed until removed. Thus, although the consumer has a variety of locksets and door handles to choose from at the time of purchase, once the lockset is installed in the consumer's door, there is no more variety available to the consumer. If a consumer later desires to have a different door handle or door knob, the consumer must purchase an entirely new lockset, remove the old lockset and install the new lockset. That can be expensive, time-consuming and tedious for consumers. Thus, whereas there is great availability of variety in other areas of a consumer's life, such as cell phone covers that allow for easy and inexpensive removal and replacement of cell phone covers, there is little variety available to consumers with regard to door handles and door knobs.

Therefore, a need exists to overcome the problems with the prior art as discussed above, and particularly for a more efficient way of providing variety in door handles and door knobs to consumers.

### SUMMARY OF THE INVENTION

Briefly, according to one embodiment, an interchangeable door handle system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

The interchangeable door handle system includes a mounting plate for placement on a door, the mounting plate having an orifice, a collar surrounding the orifice, at least one aperture in a surface of the collar, wherein the at least one aperture provides access to a lumen of the collar, at least one clip for insertion into the at least one aperture, a movable ring surrounding the collar, wherein in a first position the ring rests against the at least one clip such that the at least one clip extends through the at least one aperture and into the lumen of the collar and wherein in a second position the ring does not rest against the at least one clip such that the at least one clip does not extend into the lumen of the collar, and a door handle having a cylindrical stem including a gutter, wherein the stem is located inside of the lumen of the collar and wherein when the ring is in the first position, the at least one clip extends into the gutter of the stem, such that the door handle is secured to the collar, and wherein when the ring is in the second position the door handle is not secured to the door handle.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left- most digit of a reference number identifies the drawing in which the reference number first appears.

FIG. 1 is a perspective view of an interchangeable door handle system in a disassembled state, in accordance with one embodiment.

FIG. 2 is a perspective view of the mounting plate and spring of the interchangeable door handle system, in accordance with one embodiment.

FIG. 3 is a side view of the mounting plate and spring of the interchangeable door handle system, in accordance with one embodiment.

FIG. 4 is a perspective view of the mounting plate, ring and spindle of the interchangeable door handle system, in accordance with one embodiment.

FIG. 5 is a side view of the mounting plate, ring and spindle of the interchangeable door handle system, in accordance with one embodiment.

FIG. 6 is a perspective view of the ring of the interchangeable door handle system, in accordance with one embodiment.

FIG. 7 is a perspective view of the door handle, mounting plate, ring and spindle of the interchangeable door handle system, in accordance with one embodiment.

FIG. 8 is a perspective view of the door handle of the interchangeable door handle system, in accordance with one embodiment.

FIG. 9 is a bottom view of the door handle of the interchangeable door handle system, in accordance with one embodiment.

FIG. 10 is a side view of various stages of use of the interchangeable door handle system, in accordance with one embodiment.

FIG. 11 is a cross-sectional side view of various stages of use of the ring mechanism of the interchangeable door handle system, in accordance with one embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, an interchangeable door handle system is disclosed that overcomes the problems with the prior art as discussed above, by providing a system that allows for the easy and quick replacement of doorknobs for utility or aesthetic purposes. As an improvement over conventional locksets, even after installation Applicant's interchangeable door handle system provides the consumer with a variety of door handles to choose from. If a consumer desires to have a different door handle or door knob after installation of a lockset, the consumer must simply remove the old doorknob and install the new doorknob via a process that is simple takes very little time. Applicant's system provides a more efficient way of providing variety in door handles and door knobs to consumers.

Finally, the interchangeable door handle system provides an apparatus with a minimal number of component parts, thereby reducing the potential for failure or malfunction of the device. Also, the minimal number of component parts allows for quick and inexpensive fabrication of the device, thereby meeting the economic requirements for an interchangeable system that allows for purchase of multiple door handles. The interchangeable door handle system can be constructed of various metals, as well as plastic.

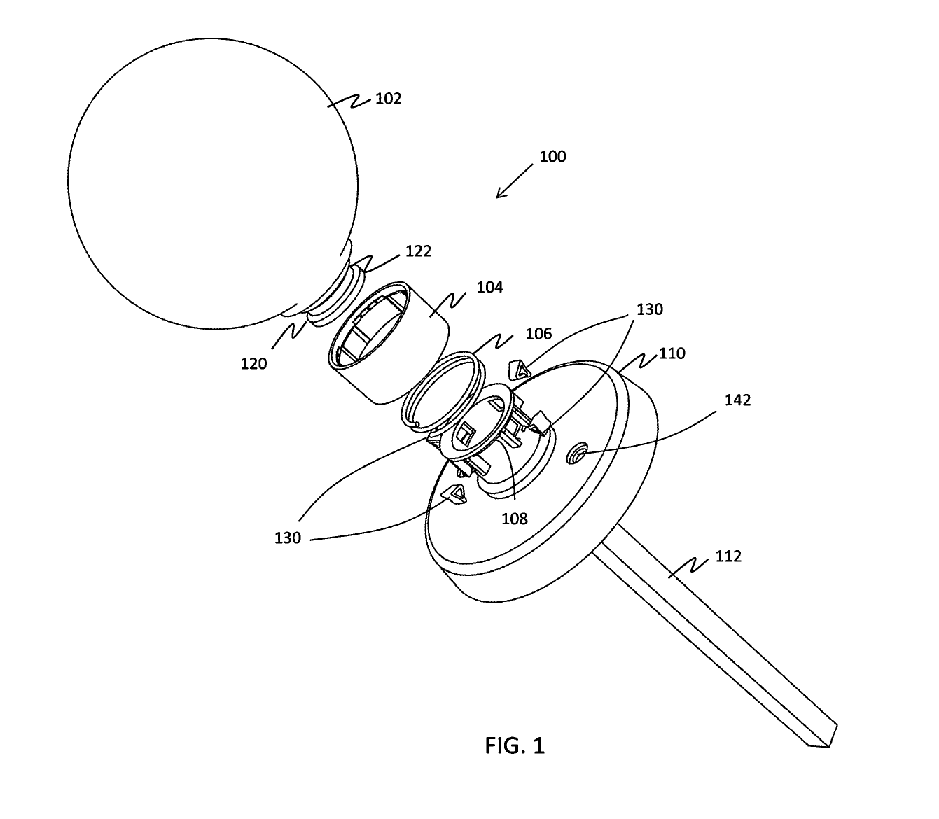

The embodiments of the interchangeable door handle system will be described heretofore with reference to FIGS. 1 through 11 below. FIG. 1 is a perspective view of an interchangeable door handle system 100 in a disassembled state, in accordance with one embodiment. The interchangeable door handle system 100 may be composed of a conventional door handle material such as stainless steel and other metal alloys, or a disposable material, such as plastic or a plastic derivative, so that the apparatus may be manufactured in an inexpensive way and purchased at a reasonable priced by consumers, allowing for purchase of multiple door handles. One or more of the components that comprise the interchangeable door handle system 100 may be stamp manufactured from a planar metallic sheet or molded from plastic using conventional plastic molding processes. FIG. 1 shows an exploded view of the components of the interchangeable door handle system 100. The low number of parts, especially moving parts, and the simplicity of the design results in an interchangeable door handle system 100 that is straightforward and inexpensive to fabricate, thereby meeting the economic requirements for an interchangeable door handle system.

FIG. 1 shows that interchangeable door handle system 100 includes a door handle 102 (shown as a door knob, though other forms of door handles are supported) and a mounting plate 110 for mounting onto a door, wherein the mounting plate 110 includes an orifice at its midpoint. The door handle 102 includes a cylindrical stem 120 at the base of the door handle 102, wherein the cylindrical stem 120 includes a gutter or depression 122 that extends along the circumference of the stem 120. In an alternative, the stem 120 may comprise an alternative shape and the gutter or depression 122 extends only a portion of the circumference of the stem 120.

Note also the mounting plate 110 includes at least one screw holes 142 for allowing insertion of a screw or other fastener that fastens the mounting plate 110 to the door. FIG. 1 shows that interchangeable door handle system 100 further includes a collar 108, comprising a tubular structure that rises in a distal direction from the mounting plate 110, wherein the collar 108 also surrounds the orifice in the mounting plate 110 and wherein the interior volume of the collar 108 is contiguous with the orifice in the mounting plate 110. The collar 108 includes at least four apertures 140 located along the surface of the collar 108, such that the apertures provide access to a lumen of the collar 108 and such that the apertures are evenly distributed around a circumference of the collar 108.

FIG. 1 also includes four separate retaining clips 130 for insertion into the fur apertures 140 in the collar 108, such that when the clips are inserted into the collar 108, the clips 130 extend through the surface of the collar 108 and extend into the lumen of the collar 108. Each clip 130 may comprise a triangular cross-section such that when the clips are inserted into the collar 108, a vertex of the clips 130 extend through the surface of the collar 108 and extend into the lumen of the collar 108. Note that although FIG. 1 discloses four clips 130 and four apertures 140, Applicant's invention supports any number of clips and apertures.

FIG. 1 further shows a spring 106 that surrounds the collar 108 and a ring 104 that comprises a tubular structure that surrounds the collar 108. The spring 106 is located between the collar 108 and the ring 104 and the spring 106 provides a force in the distal direction against the ring 104 such that the spring 106 pushes the ring 104 distally away from the mounting plate 110.

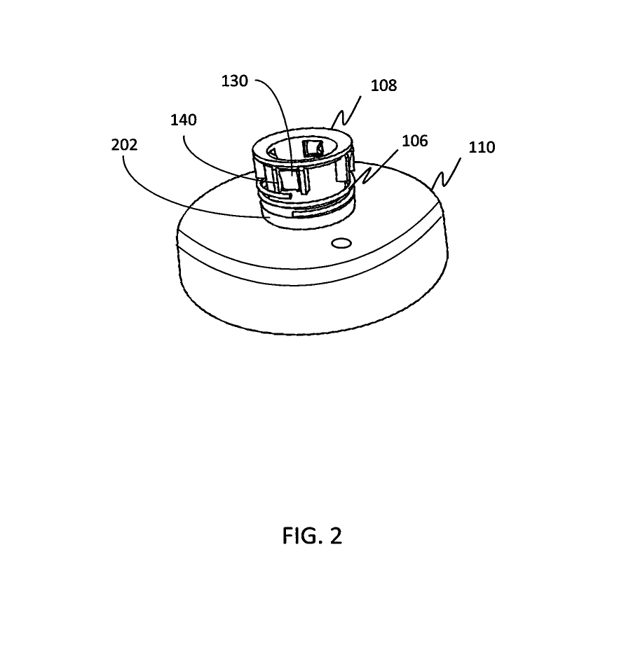

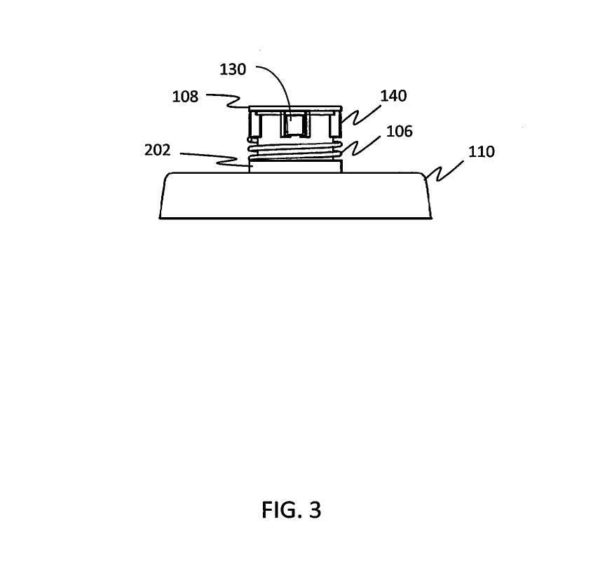

FIG. 2 is a perspective view of the mounting plate 110 and spring 106 of the interchangeable door handle system 100, in accordance with one embodiment. FIG. 2 shows spring 106 has been placed around the collar 108 such that a bottom or proximal end of the spring 106 rests on a raised lip 202 that arises from the base of collar 108. The raised lip 202 is akin to a portion of the collar 108 (located at the base of the collar 108) with an exterior circumference that is greater than an exterior circumference of a remainder of the collar 108. FIG. 3 is a side view of the mounting plate 110 and spring 106 of the interchangeable door handle system 100, in accordance with one embodiment. FIG. 3 shows a side view that illustrates how spring 106 has been placed around the collar 108 such that a bottom or proximal end of the spring 106 rests on the raised lip 202 of collar 108. Also note that in one embodiment the spring 106 only extends up to, but not extending over, the orifice 140. Further note that FIG. 2 and FIG. 3 shows the clips 130 inserted into the apertures 140.

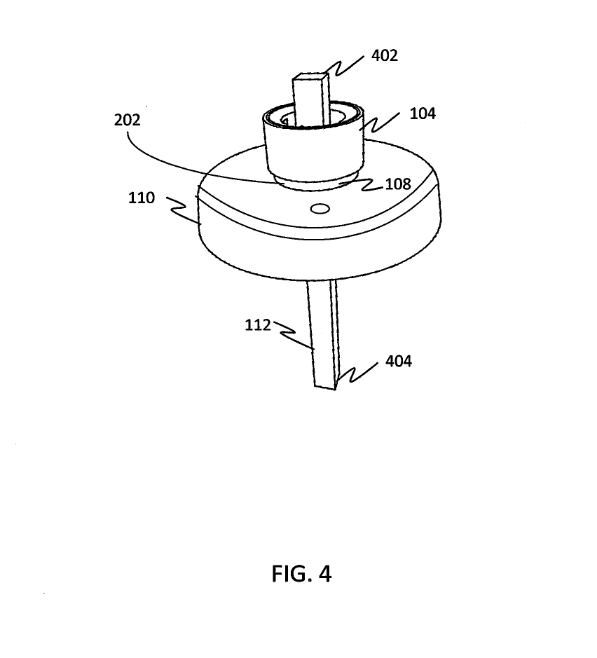

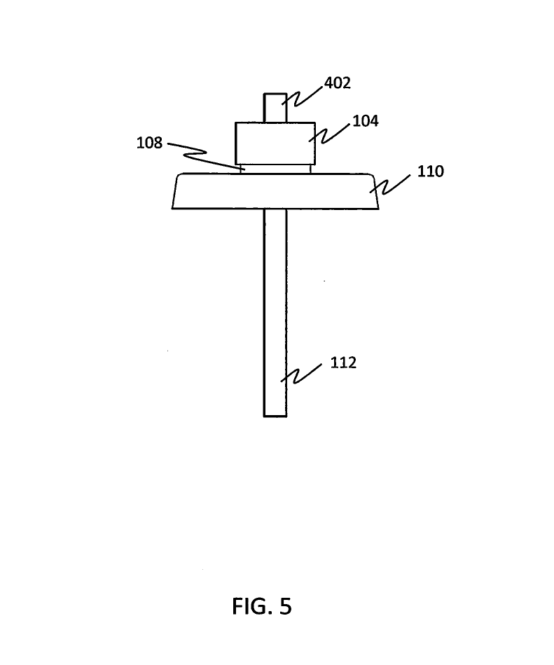

FIG. 4 is a perspective view of the mounting plate 110, ring 104 and spindle 112 of the interchangeable door handle system 100, in accordance with one embodiment. FIG. 4 shows ring 104 has been placed around the collar 108. The spring 106 (located under the ring 104 and therefore not pictured) restricts the ring 104 from resting directly on the mounting plate 110. FIG. 4 also shows spindle 112 comprising a shaft that extends through the orifice in the mounting plate 110, through the collar 108 and through the ring 104, wherein a first (distal) end 402 of the spindle 112 extends out of the collar 108 and is designed to be inserted into a bore of the door handle 102, such that rotation of the door handle 102 results in rotation of the spindle 112. A second (proximal) end 404 of the spindle 112 extends out of the proximal side of the mounting plate 110 and is designed to be inserted into a device of a lockset, such as a latch, such that the rotation of the door handle 102 results in rotation of the device of the lockset. In one embodiment, the spindle 112 has a square or rectangular cross-section. FIG. 5 is a side view of the mounting plate 110, ring 104 and spindle 112 of the interchangeable door handle system 100, in accordance with one embodiment.

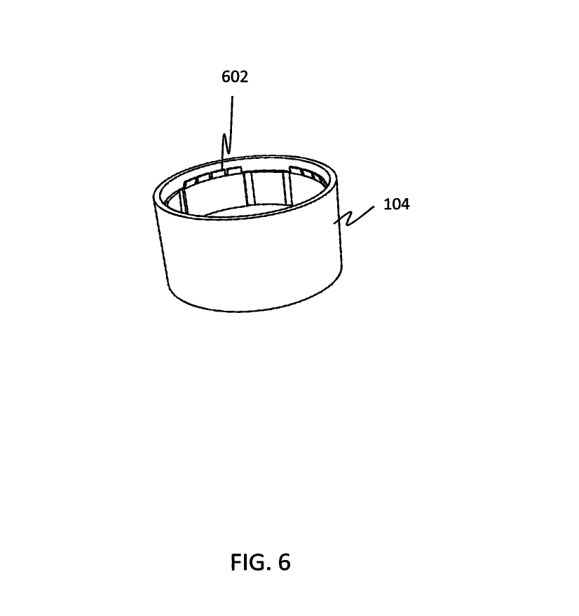

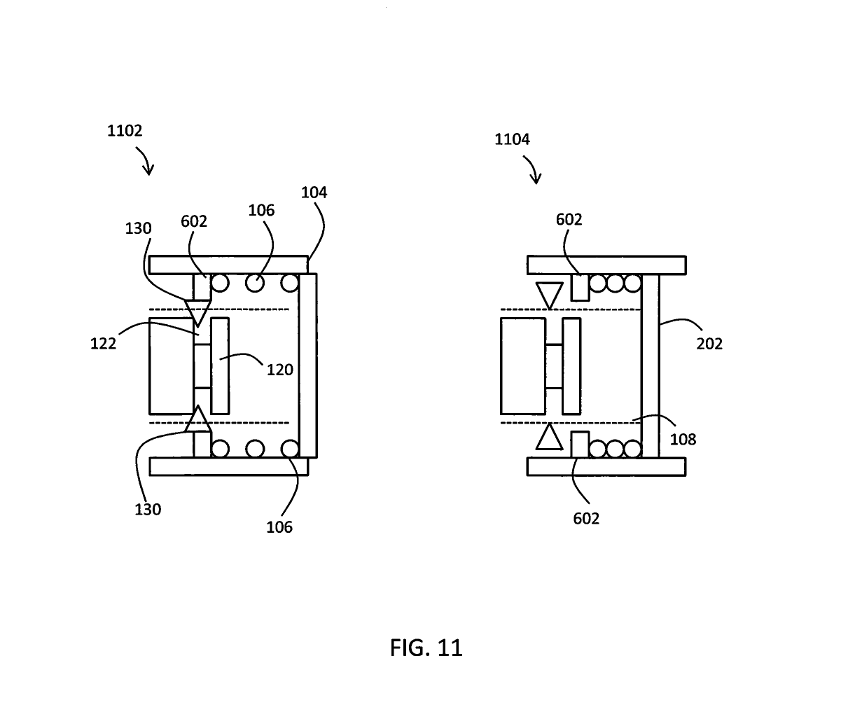

FIG. 6 is a perspective view of the ring 104 of the interchangeable door handle system 100, in accordance with one embodiment. Note that ring 104 is a movable ring surrounding the collar 108 (see FIGS. 4 and 5) wherein the ring 104 moves up and down along the collar 108. In a first position, the ring 104 rests against the clips 130 such that the clips 130 extend through the apertures 140 and into the lumen of the collar 108. In a second position, the ring 104 does not rest against the clips 130 such that the clips 130 do not extend into the lumen of the collar 108. See also FIG. 11, which is a cross-sectional side view of various stages of use of the ring mechanism of the interchangeable door handle system, in accordance with one embodiment.

FIG. 6 shows that ring 104 comprises a tubular structure that may include a lip 602 in an interior circumference of the ring 104, wherein the lip 602 provides a smaller interior circumference than a remainder of the ring 104. See FIG. 11. In the first position 1102, the lip 602 of the ring 104 rests against the clips 130 such that the clips extend through the apertures 140 and into the lumen of the collar 108. Thus, in the first position 1102, the door handle 102 is secured to the collar 108. In the second position 1104, the lip 602 of the ring 104 is separated from the clips 130 such that the clips 130 do not extend into the lumen of the collar 108. Thus, in the second position 1104, the door handle 102 is not secured to the collar 108 and therefore the door handle 102 may be removed from the collar 108.

Note that FIG. 11 shows the spring 106 surrounding the collar 108 and located between the ring 104 and the collar 108. A first end of the spring 106 rests against the lip 202 of the mounting plate 110 and a second end of the spring 106 provides a force against the lip 602 of the ring 104 so as to push the ring 104 in a distal direction towards the door handle 102. In the first position 1102, the spring 106 provides a force against the lip 602 of the ring 104 so as to push the ring 104 in the distal direction such that the lip 602 rests against the clips 130 and the clips 130 extend through the apertures 140 and into the lumen of the collar 108. In the second position 1104, the spring 106 is further compressed such that the spring 106 provides a greater force against the lip 602 of the ring 104 in the distal direction. But note that in the second position 1104, the lip 602 no longer rests against the clips 130 and therefore the clips 130 do not extend into the lumen of the collar 108, thereby allowing the door handle 102 to be removed.

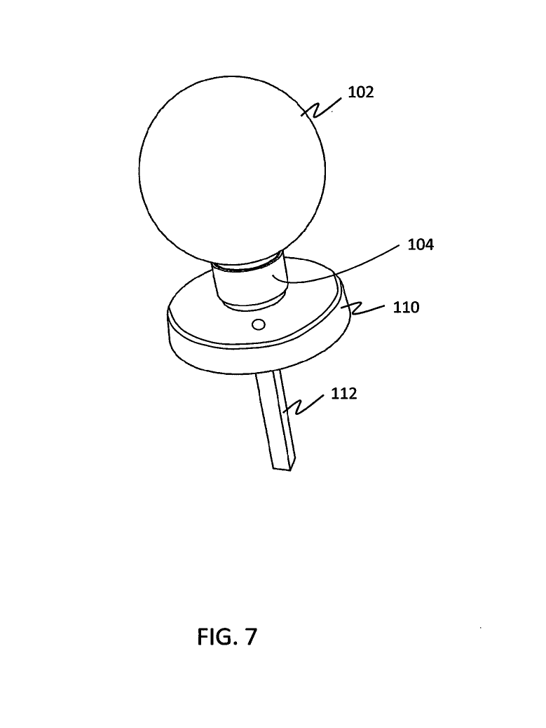

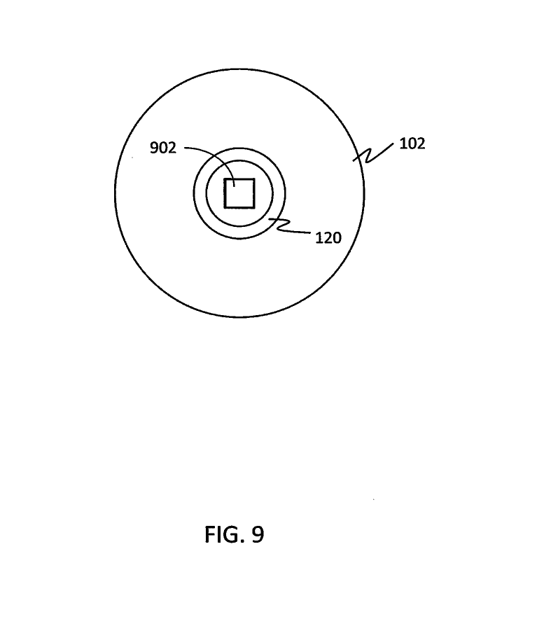

FIG. 7 is a perspective view of the door handle 102, mounting plate 110, ring 104 and spindle 112 of the interchangeable door handle system 100, in accordance with one embodiment. FIG. 7 shows that the ring 104 has been placed around the collar 108 and the door handle 102 has been inserted into the collar 108. Also note that a bore 902 (see FIG. 9) of door handle 102 has been coupled to the end 402 of the spindle 112, via a friction fit, for example, such that rotation of the door handle 102 results in rotation of the spindle 112.

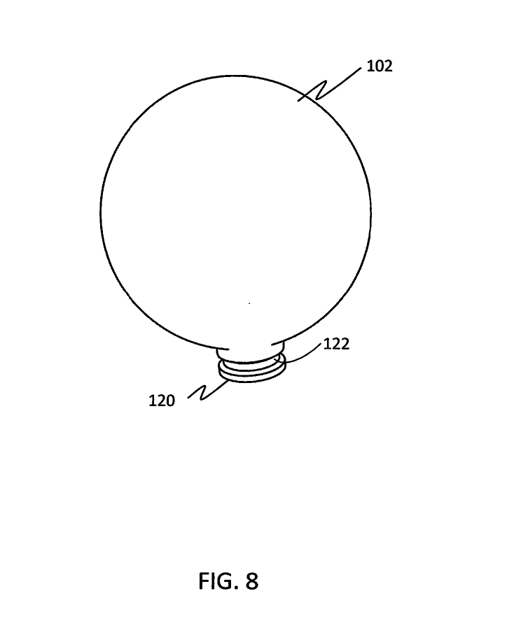

FIG. 8 is a perspective view of the door handle 102 of the interchangeable door handle system 100, in accordance with one embodiment. The door handle 102 includes a cylindrical stem 120 at the base of the door handle 102, wherein the cylindrical stem 120 includes a gutter or depression 122 that extends along the circumference of the stem 120. In an alternative, the stem 120 may comprise an alternative shape and the gutter or depression 122 extends only a portion of the circumference of the stem 120. FIG. 9 is a bottom view of the door handle 102 of the interchangeable door handle system 100, in accordance with one embodiment. FIG. 9 shows a bore 902 having a square shape so as to coincide with the square cross-section of end 402 of the spindle 112 of FIG. 5. In an alternative, the bore 402 may comprise an alternative shape.

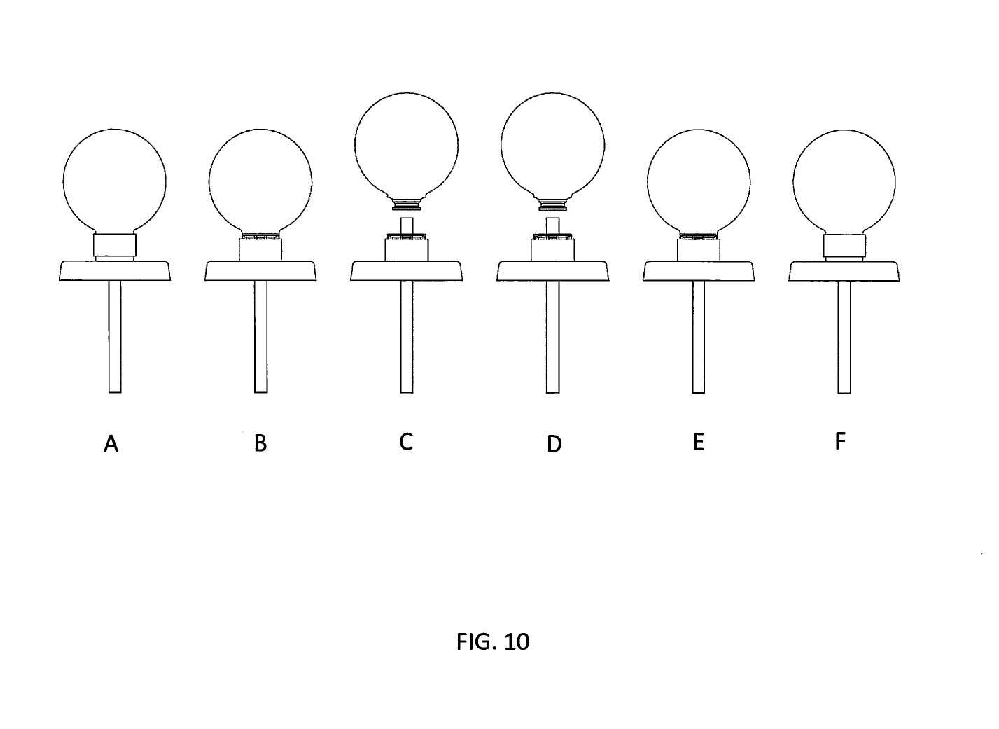

FIG. 10 is a side view of various stages of use of the interchangeable door handle system 100, in accordance with one embodiment. Stage A of FIG. 10 shows the door handle system 100 in a state that is ready for use for opening and closing doors. Note that in Stage A the ring 102 is in the first position, as shown in first position 1102 of FIG. 11. Stage B shows that the ring 102 has been moved to the second position, as shown in second position 1104 of FIG. 11. Stage C shows that the first door knob has been removed from the collar 108 and from the spindle 112, while the ring 104 remains in the second position. Stage D shows that a second door knob is being inserted onto the end 402 of spindle 112, as well as into the collar 108, while the ring 104 remains in the second position. Stage E shows that the second door knob has been fully inserted onto the end 402 of spindle 112, as well as into the collar 108, while the ring 104 remains in the second position. Stage F shows that the ring 102 has been moved to the first position, therefore the door handle system 100 is now in a state that is ready for use for opening and closing doors.

While certain embodiments of the invention have been described, other embodiments may exist. Although the subject matter has been described in language specific to structural features, it is to be understood that the subject matter defined in the appended claims is not necessarily limited to the specific features or acts described above. Rather, the specific features and acts described above are disclosed as example forms of implementing the claims.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. An interchangeable door handle system, comprising:
a mounting plate for placement on a door, the mounting plate having an orifice;
a collar surrounding the orifice;
at least one aperture in a surface of the collar, wherein the at least one aperture provides access to a lumen of the collar;
at least one clip for insertion into the at least one aperture;
a movable ring surrounding the collar, wherein in a first position the ring rests against the at least one clip such that the at least one clip extends through the at least one aperture and into the lumen of the collar and wherein in a second position the ring does not rest against the at least one clip such that the at least one clip does not extend into the lumen of the collar; and
a door handle having a cylindrical stem including a gutter, wherein the stem is located inside of the lumen of the collar and wherein when the ring is in the first position, the at least one clip extends into the gutter of the stem, such that the door handle is secured to the collar, and wherein when the ring is in the second position the door handle is not secured to the collar and may be removed.

2. The interchangeable door handle system of claim 1, wherein the at least one aperture comprises four apertures evenly distributed about a circumference of the collar.

3. The interchangeable door handle system of claim 2, wherein the at least one clip comprises four clips, each for insertion into one of the four apertures in the collar.

4. The interchangeable door handle system of claim 3, wherein the ring further comprises a lip in an interior circumference of the ring, wherein the lip provides a smaller interior circumference than a remainder of the ring.

5. The interchangeable door handle system of claim 4, wherein in the first position the lip of the ring rests against the at least one clip such that the at least one clip extends through the at least one aperture and into the lumen of the collar and wherein in the second position the lip of the ring is separated from the at least one clip such that the at least one clip does not extend into the lumen of the collar.

6. The interchangeable door handle system of claim 5, further comprising a spring surrounding the collar and located between the ring and the collar, wherein a first end of the spring rests against the mounting plate and a second end of the spring provides a force against the lip of the ring so as to push the ring in a distal direction.

7. The interchangeable door handle system of claim 6, wherein in the first position the spring provides a force against the lip of the ring so as to push the ring in the distal direction such that the lip of the ring rests against the at least one clip and the at least one clip extends through the at least one aperture and into the lumen of the collar and wherein in the second position the spring is further compressed such that the spring provides a greater force against the lip of the ring in the distal direction.

8. The interchangeable door handle system of claim 7, further comprising a bore in a stem of the door handle.

9. The interchangeable door handle system of claim 7, further comprising a spindle comprising a shaft that extends through the orifice in the mounting plate, wherein a first end of the spindle is inserted into the bore of the door handle, such that rotation of the door handle results in rotation of the spindle.

10. The interchangeable door handle system of claim 1, further comprising a pair of screw holes in the mounting plate for insertion of screws that secure the mounting plate to a door.

11. An interchangeable door handle system, comprising:
a mounting plate for placement on a door, the mounting plate having an orifice;
a collar surrounding the orifice;
four apertures located in a surface of the collar, wherein the four apertures provide access to a lumen of the collar;
four clips, each for insertion into one of the four apertures;
a movable ring surrounding the collar, wherein in a first position the ring rests against the clips such that the clips extend through the apertures and into the lumen of the collar and wherein in a second position the ring does not rest against the clips such that the clips do not extend into the lumen of the collar; and
a door handle having a cylindrical stem including a gutter, wherein the stem is located inside of the lumen of the collar and wherein when the ring is in the first position, the clips extend into the gutter of the stem, such that the door handle is secured to the collar, and wherein when the ring is in the second position the door handle is not secured to the collar and may be removed.

12. The interchangeable door handle system of claim 11, wherein the ring further comprises a lip in an interior circumference of the ring, wherein the lip provides a smaller interior circumference than a remainder of the ring.

13. The interchangeable door handle system of claim 12, wherein in the first position the lip of the ring rests against the clips such that the clips extend through the apertures and into the lumen of the collar and wherein in the second position the lip of the ring is separated from the clips such that the clips do not extend into the lumen of the collar.

14. The interchangeable door handle system of claim 13, further comprising a spring surrounding the collar and located between the ring and the collar, wherein a first end of the spring rests against the mounting plate and a second end of the spring provides a force against the lip of the ring so as to push the ring in a distal direction.

15. The interchangeable door handle system of claim 14, wherein in the first position the spring provides a force against the lip of the ring so as to push the ring in the distal direction such that the lip of the ring rests against the clips and the clips extend through the apertures and into the lumen of the collar and wherein in the second position the spring is further compressed such that the spring provides a greater force against the lip of the ring in the distal direction.

16. The interchangeable door handle system of claim 15, further comprising a bore in a stem of the door handle.

17. The interchangeable door handle system of claim 16, further comprising a spindle comprising a shaft that extends through the orifice in the mounting plate, wherein a first end of the spindle is inserted into the bore of the door handle, such that rotation of the door handle results in rotation of the spindle.

18. The interchangeable door handle system of claim 17, further comprising a pair of screw holes in the mounting plate for insertion of screws that secure the mounting plate to a door.
